(19) United States
(12) Patent Application Publication
(10) Pub. No.: US 2011/0083014 A1
(43) Pub. Date: Apr. 7, 2011

(54) METHOD AND APPARATUS FOR GENERATING TEMPORARY GRUU IN IMS SYSTEM

(75) Inventor: Deoksoo LIM, Suwon-si (KR)

(73) Assignee: Samsung Electronics Co., Ltd., Suwon-si (KR)

(21) Appl. No.: 12/896,490

(22) Filed: Oct. 1, 2010

(30) Foreign Application Priority Data
Oct. 1, 2009 (KR) 10-2009-0093885

(51) Int. Cl. G06F 21/00; H04L 9/32

(52) U.S. Cl. 713/168; 726/3

(57) ABSTRACT

There is provided a method and apparatus for generating a temporary Globally Routable User Agent URI (GRUU) in an IP Multimedia Subsystem (IMS) system. The method and apparatus can generate a temporary GRUU without the need to generate and manage a separate database (DB). Since the previously registered user's aor and Instance Id cannot be found if a DB managing an I value I_i and an aor-Instance Id pair is lost, the method generates a temporary GRUU based on the current timestamp, an Address Of Record (aor) and an Instance Id (or Private User Identity).

### PRIORITY

This application claims priority under 35 U.S.C. §119(a) to a Korean Patent Application filed in the Korean Intellectual Property Office on Oct. 1, 2009 and assigned Serial No. 10-2009-0093885, the entire disclosure of which is incorporated herein by reference.

### BACKGROUND OF THE INVENTION

1. Field of the Invention

The present invention relates generally to an IP Multimedia Subsystem (IMS) system, and more particularly, to a method and apparatus for generating a temporary Globally Routable User Agent Uniform Resource Identifier (URI) (GRUU) in an IMS system based on the Internet Protocol (IP).

2. Description of the Related Art

In line with the rapid development of mobile communication and Internet technologies and the increasing demand for various services by subscribers, the recent mobile communication services have been advanced to provide not only the existing voice call service, but also a high-speed packet data service, capable of transmitting massive digital data as well as E-mail and still images, using mobile terminals. To provide the high-speed packet data service, mobile communication systems have been evolving from the voice-based Circuit Switched (CS) domain to the packet-based Packet Switched (PS) domain.

A Core Network (CN) providing multimedia services over the Internet is making progress from the existing circuit-switched CN to a packet-switched CN, further evolving into an IP-based CN. A communication system providing IP Multimedia services (IM service) to subscribers over the IP-based CN is called an IP Multimedia Subsystem (IMS). In the Third Generation Partnership Project (3GPP) and Third Generation Partnership Project-2 (3GPP2), many studies are underway to seamlessly provide all IP service over the IMS.

The IMS is an aggregate of signalings and bearers related to network elements, and should be able to approach the web-based technology for voice, video, message, data and wireless subscribers. Additionally, since the IMS provides various types of packet data services based on an IP transmission protocol, IMS users may exchange multimedia content such as photos, video clips and sound clips, through session-based messages.

FIG. 1 shows the architecture of a general IMS system.

The IMS system is divided into a sending network, an IMS network, and a receiving network. For convenience, however, FIG. 1 shows a sending network and an IMS only. The IMS network is based on a Wideband Code Division Multiple Access (WCDMA) network, which includes a wireless access network including a User Equipment (UE) 100, a Node B 105 and a Radio Network Controller (RNC) 110, and packet gateway nodes include a Serving GPRS Support Node (SGSN) 115 and a Gateway GPRS Support Node (GGSN) 117, and the IMS network includes an IMS node 120 including a Call Session Control Function (CSCF) 126 and a Home Subscriber Server (HSS) 125.

The CSCF 126 is an important functional element of the so-called IM CN subsystem for providing an IP Multimedia (IM) service in IMS. The CSCF 126 performs registration and multimedia call processing based on a Session Initiation Protocol (SIP), and the HSS 125, integrated into a Home Location Register (HLR) of the existing mobile communication network or legacy domain, performs mobility management and authentication for IM service users.

The CSCF 126 includes a Proxy-CSCF (P-CSCF) 127, a Serving CSCF (S-CSCF) 129, and an Interrogating CSCF (I-CSCF) 128 according to its location and role. Functions of these CSCFs are as follows.

The P-CSCF 127 is the first point where the UE 100 accesses the IM service network, and exists in the same domain as GGSN. The P-CSCF 127, which exchanges SIP request/response messages with the UE 100, forwards an SIP message received from the UE 100 to the S-CSCF 129, and forwards an SIP message received from the S-CSCF 129 to the UE 100.

The S-CSCF 129 manages the session status of the UE 100, stores subscriber information of the UE 100, received from the HSS 125, performs subscriber authentication in cooperation with the HSS 125, and sends a SIP message received from the P-CSCF 127 to the I-CSCF 128.

The I-CSCF 128, which is the first point where it accesses another home network (operator network), routes a SIP message received from another home network to the S-CSCF 129.

The above-stated S-CSCF 129 of the IMS system defines a GRUU in draft-ietf-sip-gruu-15 (see tools.ietf.org/html/draft-ietf-sip-gruu-15), as follows.

Globally Routable User Agent URI (GRUU) represents a globally routable unique user agent identifier. To route a call to a specific User Agent (UA) instance, some applications of SIP request to create and distribute a Uniform Resource Identifier (URI) that can be used by someone accessing the Internet. The URI being routed to a specific UA instance is called “GRUU.”

GRUU is divided into a public GRUU and a temporary GRUU.

The public GRUU is always the same even though the registration is refreshed, and it is generated by inputting an Instance Identifier (Id) as a value of a “gr” URI parameter of Address Of Record (aor).

Regarding the temporary GRUU, a new temporary GRUU should be created when the registration is refreshed, and should be accumulated and managed during a registration period.

A temporary GRUU generation method proposed in Appendix A of draft-ietf-sip-gruu-15 is as follows.

A “register” (the S-CSCF 129 in the IMS network and hereafter will be referred to as the ‘S-CSCF 129’) stores and manages a 48-bit counter I, which is initialized to 0, in a database DB. When generating a first temporary GRUU for specific aor and Instance Id, the S-CSCF 129 stores an I value I_i in the DB in association with a relevant aor-Instance Id pair, and increases the I value by 1. The S-CSCF 129 should manage a pair of K_e and K_a as a symmetric key. When the counter I is reset, the S-CSCF 129 should re-generate a symmetric key, and maintain the previous symmetric key for a specific time. To generate a temporary GRUU, the S-CSCF 129 should generate an 80-bit random distinguisher value D. The DB, in which I_i and aor-Instance Id pair are stored in association with each other, and the symmetric key are shared by the P-CSCF 127 and the S-CSCF 129. The P-CSCF 127 includes all entities playing a proxy role.

To manage a separate DB, in which I_i and aor-Instance Id pair are stored in relation to each other, and a variable symmetric key, as well as resources (such as a RAM and hard drive) are additionally needed. If the DB managing I_i and aor-Instance Id pair is lost, it is not possible to know the previously registered user's aor and Instance Id. Additionally, to decrypt a temporary GRUU in a P-CSCF or an I-CSCF, a separate interface is needed that shares a symmetric key and a separate DB (for storing I_i and aor-Instance Id pair in association with each other).

### SUMMARY OF THE INVENTION

An aspect of the present invention is to address at least the above-mentioned problems and/or disadvantages and to provide at least the advantages described below. Accordingly, an aspect of the embodiments of the present invention is to provide a temporary GRUU generation method and apparatus for avoiding the need to generate and manage a separate DB in an IMS system.

Another aspect of the embodiments of the present invention is to provide a method and apparatus for generating a temporary GRUU considering that if a DB managing I_i and aor-Instance Id pair is lost, it is not possible to know the previously registered user's aor and Instance Id, in an IMS system.

In accordance with one aspect of the present invention, there is provided a method for generating a temporary Globally Routable User Agent URI (GRUU) by a Serving-Call Session Control Function (S-CSCF) in an IP Multimedia Subsystem (IMS) system, in which upon receiving a registration request message from an Interrogating-Call Session Control Function (I-CSCF), the S-CSCF performs an authentication procedure, generates a temporary GRUU based on a current timestamp, and an Address Of Record (aor) and an Instance Identifier (Id) included in the registration request message, and transmits the generated temporary GRUU to a User Equipment (UE) along with a contact header.

In accordance with another aspect of the present invention, there is provided a method for generating a temporary Globally Routable User Agent URI (GRUU) by a Serving-Call Session Control Function (S-CSCF) in an IP multimedia subsystem (IMS) system, in which upon receiving a re-registration request message from an Interrogating-Call Session Control Function (I-CSCF), the S-CSCF generates a temporary GRUU using a current timestamp, and an Address Of Record (aor) and an instance Identifier (Id) included in the re-registration request message without an authentication procedure, and if a Call-Id header used during initial registration has been changed, the S-CSCF changes subscriber information, and transmits the generated temporary GRUU to a User Equipment (UE) along with a contact header.

In accordance with another aspect of the present invention, there is provided a method for determining validity of a temporary Globally Routable User Agent URI (GRUU) by a receiving Serving-Call Session Control Function (S-CSCF) in an IP multimedia subsystem (IMS) system, in which the receiving S-CSCF receives an INVITE message with a temporary GRUU from a receiving Interrogating-Call Session Control Function (I-CSCF), and if a Request-URI included in the INVITE message corresponds to the temporary GRUU, the receiving S-CSCF acquires a timestamp, a public Identifier (Id) and a private Id by decrypting the temporary GRUU, compares a timestamp value obtained by the decryption with a timestamp value being managed in subscriber information, and determines validity of the temporary GRUU according to the comparison result.

In accordance with another aspect of the present invention, there is provided a method for determining validity of a temporary Globally Routable User Agent URI (GRUU) by a sending Serving-Call Session Control Function (S-CSCF) in an IP multimedia subsystem (IMS) system, in which the sending S-CSCF acquires a timestamp, a public Identifier (Id) and a private Id by decrypting a temporary GRUU included in a contact header, compares a timestamp value obtained by the decryption with a timestamp value being managed in subscriber information, and determines validity of the temporary GRUU according to the comparison result.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a diagram showing architecture of a general IMS system;

FIG. 2 is a flow diagram showing an initial registration process in an IMS system according to an embodiment of the present invention;

FIG. 3 is a flow diagram showing a re-registration process in an IMS system according to an embodiment of the present invention;

FIG. 4 is a flow diagram showing a temporary GRUU validity check procedure in an IMS system according to an embodiment of the present invention;

FIG. 5 is a flowchart showing the initial registration process of FIG. 2 by an S-CSCF in an IMS system according to an embodiment of the present invention;

FIG. 6 is a flowchart showing the re-registration process of FIG. 3 by an S-CSCF in an IMS system according to an embodiment of the present invention; and

FIG. 7 is a flowchart showing the temporary GRUU validity check procedure of FIG. 4 by an S-CSCF in an IMS system according to an embodiment of the present invention.

Throughout the drawings, the same drawing reference numerals will be understood to refer to the same elements, features and structures.

### DETAILED DESCRIPTION OF THE EMBODIMENTS OF THE PRESENT INVENTION

Embodiments of the present invention will now be described in detail with reference to the accompanying drawings. In the following description, specific details such as detailed configuration and components are merely provided to assist the overall understanding of the embodiments of the present invention. Therefore, it should be apparent to those skilled in the art that various changes and modifications of the embodiments described herein can be made without departing from the scope and spirit of the invention. Additionally, descriptions of well-known functions and constructions are omitted for clarity and conciseness.

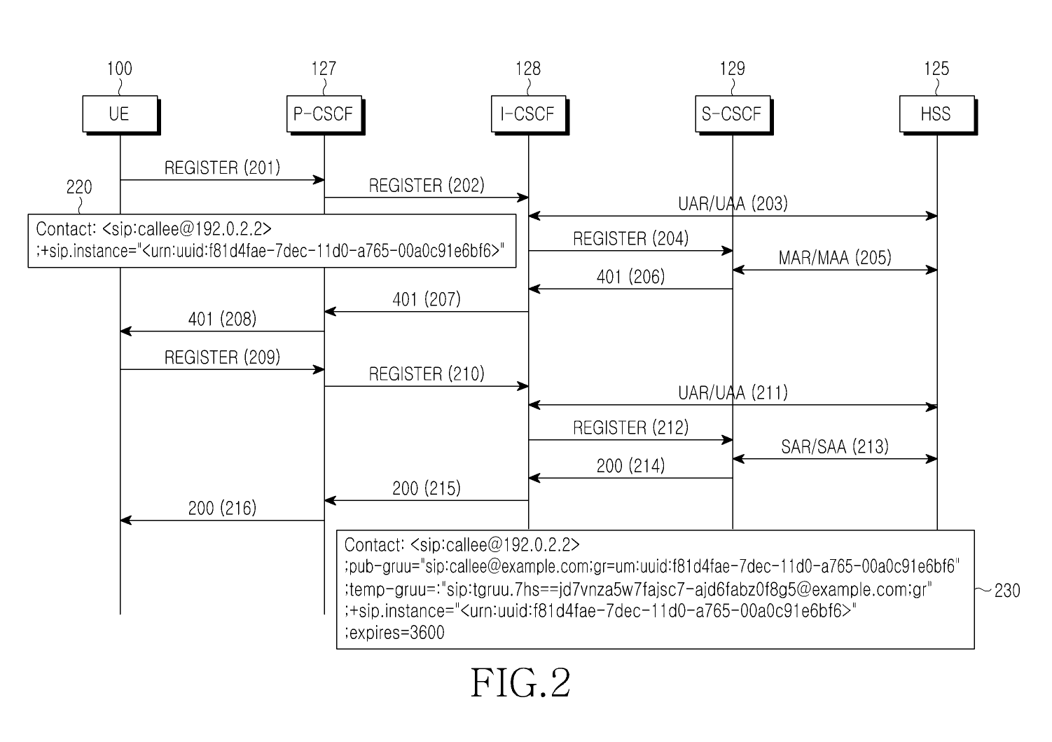

FIG. 2 shows an initial registration process in an IMS system according to an embodiment of the present invention.

In step 201, a UE 100 sends a registration request message REGISTER to a P-CSCF 127. A Contact header of the registration request message may include an Instance Id as shown by reference numeral 220. A Private Id may be included in an Authorization header, and an aor or Public Id may be included in a To header.

Upon receiving the registration request message from the UE 100, the P-CSCF 127, though not shown, performs a Domain Name System (DNS) query operation, in which the P-CSCF 127 sends to a Domain Name Server (not shown) a DNS query message including a destination URI of the registration request message received from the UE 100. Based on the destination URI included in the DNS query message, the DNS selects a proper I-CSCF 128 and sends to the P-CSCF 127 a DNS query response message including an address of the selected I-CSCF 128. Upon acquiring the address of the I-CSCF 128, the P-CSCF 127 sends the registration request message from the UE 100 to the I-CSCF 128 in step 202. The registration request message sent to the I-CSCF 128 may be a registration request message that the P-CSCF 127 has edited after receiving it from the UE 100.

Upon receiving the registration request message from the P-CSCF 127, the I-CSCF 128 acquires an address of an HSS 125 from a Server Locator Function (SLF, not shown), and sends a User Authorization Request (UAR) message to the HSS 125 using the acquired address, in step 203. Based on the UAR message received from the I-CSCF 128, the HSS 125 selects an S-CSCF 129 proper for the UE 100, and sends a User Authorization Answer (UAA) message including information about the selected S-CSCF 129 to the I-CSCF 128, in step 203.

In step 204, based on the UAA message, the I-CSCF 128 may establish the S-CSCF 129 that will handle the registration request from the UE 100, and then send the registration request message to the established S-CSCF 129. The S-CSCF 129 acquires a pair of a Private Id (or Instance Id) and a Public Id of a subscriber from the registration request message received from the I-CSCF 128, and checks for the presence/absence of an Authentication Vector (AV) corresponding to the Private Id. In the absence of the AV, the S-CSCF 129 sends an AV request message to the HSS 125 in step 205. The AV request message may include a subscriber's Private Id and information about the number of required AVs. A Multimedia Authorization Request (MAR) message may be used as the AV request message.

The HSS 125 generates as many AVs as the number requested by the S-CSCF 129, and sends an AV answer message including the generated AVs to the S-CSCF 129 in step 205. A Multimedia Authorization Answer (MAA) message may be used as the AV answer message.

In step 206, upon receiving the AV(s) from the HSS 125, the S-CSCF 129 stores the acquired AV together with the subscriber's Private Id, and sends to the I-CSCF 128 a 401 response message including the acquired AV and the subscriber's Private Id. Upon receiving the 401 response message from the S-CSCF 129, the I-CSCF 128 forwards it to the P-CSCF 127 in step 207, and the P-CSCF 127 forwards the 401 response message to the UE 100 in step 208. The UE 100 performs authentication for the IMS network using the information included in the 401 response message.

As a result of the authentication, however, if a message authentication code and an expected message authentication code are the same, the UE 100 generates an authentication response value, using a secret key it has previously shared with the HSS 125, and a specific function defining a random number acquired from the 401 response message as its input value. Thereafter, in step 209, the UE 100 sends to the P-CSCF 127 an authentication response message (REGISTER in FIG. 2) including the generated authentication response value and the subscriber's Private Id.

In step 210, the P-CSCF 127 forwards the authentication response message from the UE 100 to the I-CSCF 128. Upon receiving the authentication response message, the I-CSCF 128 sends a UAR message to the HSS 125 in step 211. Based on the UAR message received from the I-CSCF 128, the HSS 125 selects an S-CSCF 129 proper for the UE 100 and sends a UAA message including information about the selected S-CSCF 129 to the I-CSCF 128, in step 211.

In step 212, based on the UAA message, the I-CSCF 128 sends the authentication response message to the S-CSCF 129 that will perform authentication response for the UE 100. Upon receiving the authentication response message, the S-CSCF 129 performs authentication for the subscriber and sends a Server Assignment Request (SAR) message to the HSS 125 in step 213, if the authentication is successful. In response to the SAR message, the HSS 125 sends a Server Assignment Answer (SAA) message to the S-CSCF 129 in step 213. Upon receiving the SAA message, the S-CSCF 129 generates a temporary GRUU using the current timestamp, the Public Id (or aor), and the Private Id (or Instance Id), as shown by reference numeral 230, and stores the timestamp used for generation of the temporary GRUU when storing the subscriber information.

After storing the subscriber information, the S-CSCF 129 sends a 200 OK response message to the I-CSCF 128 in step 214. The stored subscriber information is used when the S-CSCF 129 later triggers a proper IM service to be provided to the UE 100.

The I-CSCF 128 sends the 200 OK response message to the P-CSCF 127 in step 215, and the P-CSCF 127 sends the 200 OK response message to the UE 100 in step 216.

The S-CSCF 129 provides a temporary GRUU generation method as follows.

M = TS || ‘ ‘ || aor || ‘ ‘ || Instance-Id
E = AES-CBC-Encrypt(K_e, M)
Temp-Gruu-userpart = base64 (E)

M includes timestamp, aor, and Instance Id. In this algorithm, the timestamp constituting M represents a reference time for a registration expiration time when the S-CSCF 129 handles a 200 OK response to REGISTER, ∥ represents concatenation, and ‘ ’represents a space. An encryption result value is output by encrypting M and a fixed Key K_e using an Advanced Encryption Standard (AES) algorithm, and ‘userpart’ of the temporary GRUU is generated by applying the encryption result value to base64 for URL.

Since aor and Instance-Id (replaceable with Private Id in 3GPP) are included as elements constituting the temporary GRUU, the aor and Instance Id may be found by decrypting the temporary GRUU using a symmetric key, and as for a timestamp for validity check, the timestamp already included in registration information of an aor-Instance Id pair is used, making it unnecessary to generate and manage a separate DB. In case of 3GPP, if a P-CSCF and an I-CSCF share the fixed symmetric key managed in an S-CSCF and the temporary GRUU generation algorithm, even the P-CSCF and I-CSCF may decrypt the temporary GRUU.

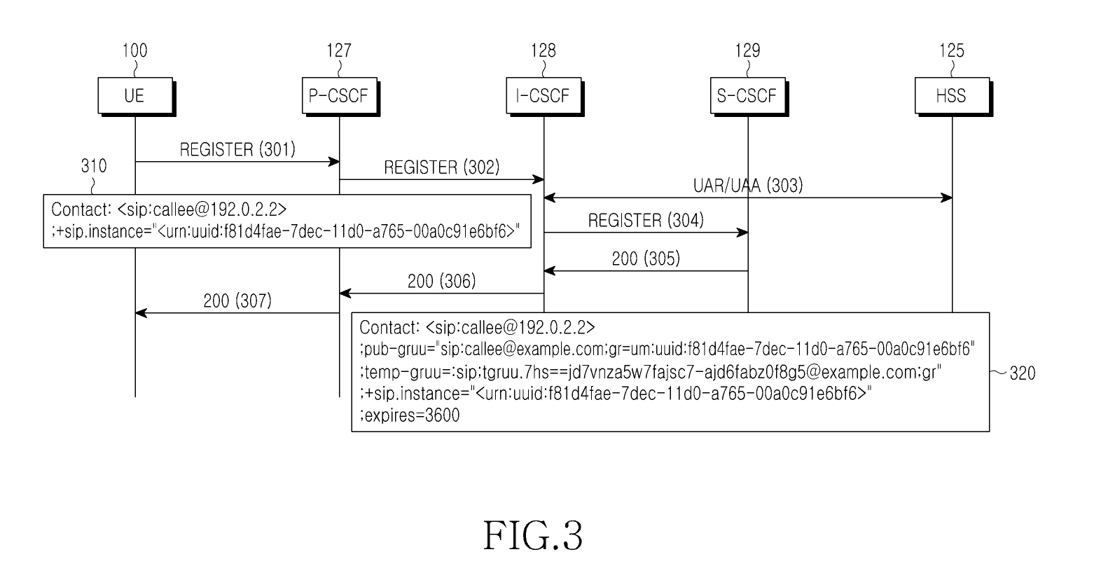

FIG. 3 shows a re-registration process in an IMS system according to an embodiment of the present invention.

Since its difference from FIG. 2 lies in the re-registration process, FIG. 3 does not show the authentication process. That is, steps 201 to 208 in FIG. 2 are omitted. Thus, step 301 in FIG. 3 corresponds to step 209 in FIG. 2.

In step 301, a UE 100 sends a REGISTER for re-registration to a P-CSCF 127. A Contact header of the REGISTER message may include an Instance Id as shown by reference numeral 310. A Private Id may be included in an Authorization header, and an aor (or Public Id) may be included in a To header. Upon receiving the re-registration request message, the P-CSCF 127, though not shown, performs a DNS query operation, in which the P-CSCF 127 sends to a DNS (not shown) a DNS query message including a destination URI of the re-registration request message received from the UE 100. Based on the destination URI included in the DNS query message, the DNS selects a proper I-CSCF 128, and sends to the P-CSCF 127 a DNS query response message including an address of the selected I-CSCF 128. Upon acquiring the address of the I-CSCF 128, the P-CSCF 127 sends the re-registration request message from the UE 100 to the I-CSCF 128 in step 302. The re-registration request message being sent to the I-CSCF 128 may be a re-registration request message that the P-CSCF 127 has edited after receiving from the UE 100.

Upon receiving the re-registration request message from the P-CSCF 127, the I-CSCF 128 acquires an address of an HSS 125 from an SLF (not shown) and sends a UAR message to the HSS 125 using the acquired address, in step 303. Based on the UAR message received from the I-CSCF 128, the HSS 125 selects an S-CSCF 129 proper for the UE 100 and sends a UAA message including information about the selected S-CSCF 129 to the I-CSCF 128 in step 303.

In step 304, the I-CSCF 128 acquires information about the S-CSCF 129 assigned to the UE 100 from the UAA message, and send the re-registration request message to the assigned S-CSCF 129. Upon receiving the re-registration request message, the S-CSCF 129 generates a temporary GRUU and changes subscriber information, using the current timestamp, the Public Id (or aor) and the Private Id (or Instance Id), as shown by reference numeral 320. Since a timestamp changes when the temporary GRUU is generated during re-registration, the timestamp is different from that of the temporary GRUU generated during initial registration. It cannot be determined that in the generated temporary GRUU, a specific character is a timestamp due to the application of an AES algorithm and base64. Two temporary different GRUUs are generated. For example, in case of the userpart, if a temporary GRUU_{—}1 is given as “tgruu.NwPeIjk3FofrWrmwNoWH5eVxXOYqkN”, a temporary GRUU_{—}2 may become “tgruu.O5OO17iLDZIk8dCVXkGpQe9fyFV8Qz”. Reference numeral 320 represents an unchanged previous temporary GRUU.

The timestamp value is reflected in the subscriber information only when a Call-Id used for the S-CSCF 129 is changed. The previously generated temporary GRUU is invalid. However, the existing timestamp value should be maintained intact if Call-Id has not been changed.

The S-CSCF 129 sends a 200 OK message to the UE 100 via the I-CSCF 128 and the P-CSCF 127 through steps 305, 306 and 307, the 200 OK message having a Contact header in which the generated GRUU information (i.e., the last generated temporary GRUU) is included.

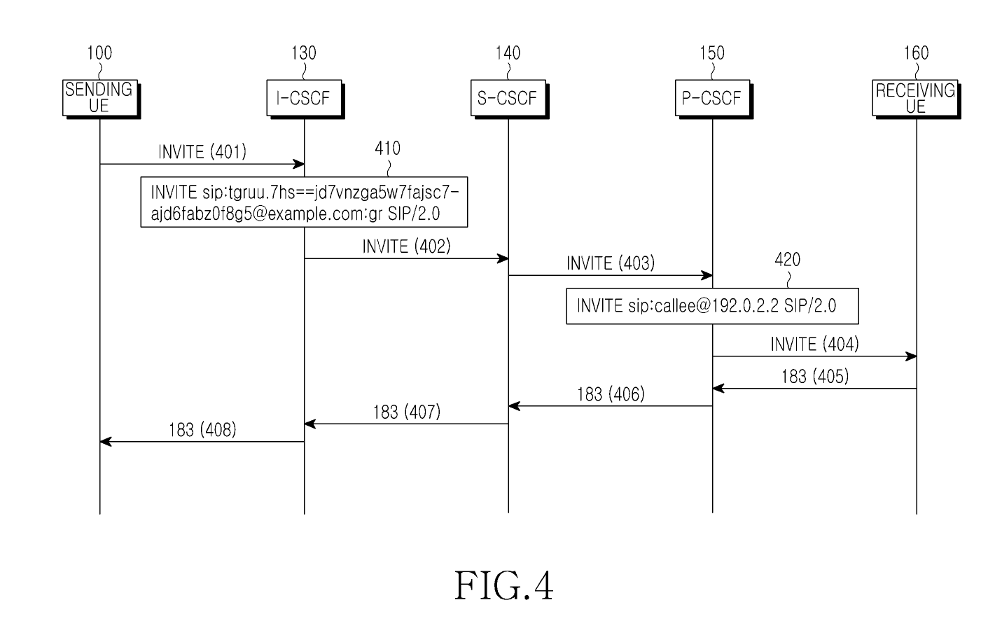

FIG. 4 shows a temporary GRUU validity check procedure in an IMS system according to an embodiment of the present invention.

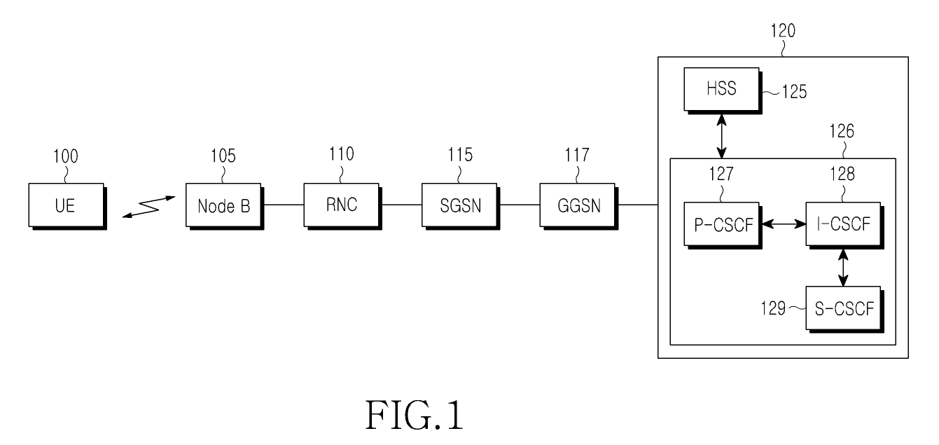

A sending UE 100 in FIG. 4 may correspond to a receiving UE (not shown) in FIGS. 1 to 3. Additionally, an I-CSCF 130, an S-CSCF 140, and a P-CSCF 150 shown in FIG. 4 may correspond to those in a receiving IMS network.

Upon receiving an INVITE message with a recipient's temporary GRUU included in a Request-URI from the sending UE 100 in step 401, the I-CSCF 130 selects the S-CSCF 140 and sends the INVITE message to the selected S-CSCF 140 in step 402. Upon receiving the INVITE message, the S-CSCF 140 determines a timestamp, a Public Id and a Private Id by decrypting the temporary GRUU if the Request-URI corresponds to a temporary GRUU. Thereafter, the S-CSCF 140 compares the decrypted timestamp with the timestamp being managed as the subscriber, and sends the INVITE message to the P-CSCF 150 in step 403, treating the temporary GRUU as a proper GRUU, if the timestamp of the temporary GRUU included in the Request-URI, i.e., the decrypted timestamp, is greater than or equal to the timestamp being managed as the subscriber. Otherwise, if the decrypted timestamp is less than the existing timestamp, the S-CSCF 140, though not shown, sends a 480 Temporarily Unavailable message to treat the temporary GRUU as an improper GRUU.

Since steps 403 to 408 are the same as those in the general call processing, a detailed description thereof is omitted.

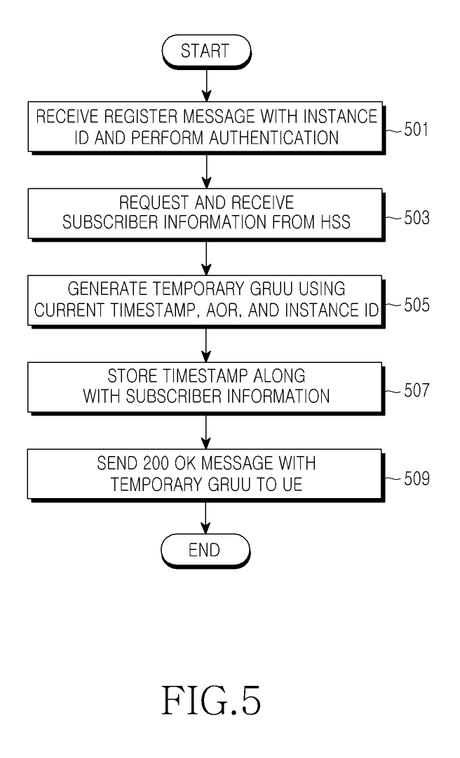

FIG. 5 shows the initial registration process of FIG. 2 by an S-CSCF in an IMS system according to an embodiment of the present invention.

In step 501, the S-CSCF 129 receives a REGISTER message with an Instance Id from an I-CSCF 128, and performs an authentication procedure. Thereafter, in step 503, the S-CSCF 129 sends an SAR message to an HSS 125. In response to the SAR message, the HSS 125 sends an SAA message to the S-CSCF 129. By doing so, the S-CSCF 129 receives subscriber information from the HSS 125. In step 505, the S-CSCF 129 generates a temporary GRUU using the current timestamp, a Public Id (or aor) and a Private Id (or Instance Id) as shown by reference numeral 230 in FIG. 2. In step 507, the S-CSCF 129 stores the timestamp used for generation of the temporary GRUU, together with subscriber information. In step 509, the S-CSCF 129 sends to a UE 100 a 200 OK message with the generated temporary GRUU.

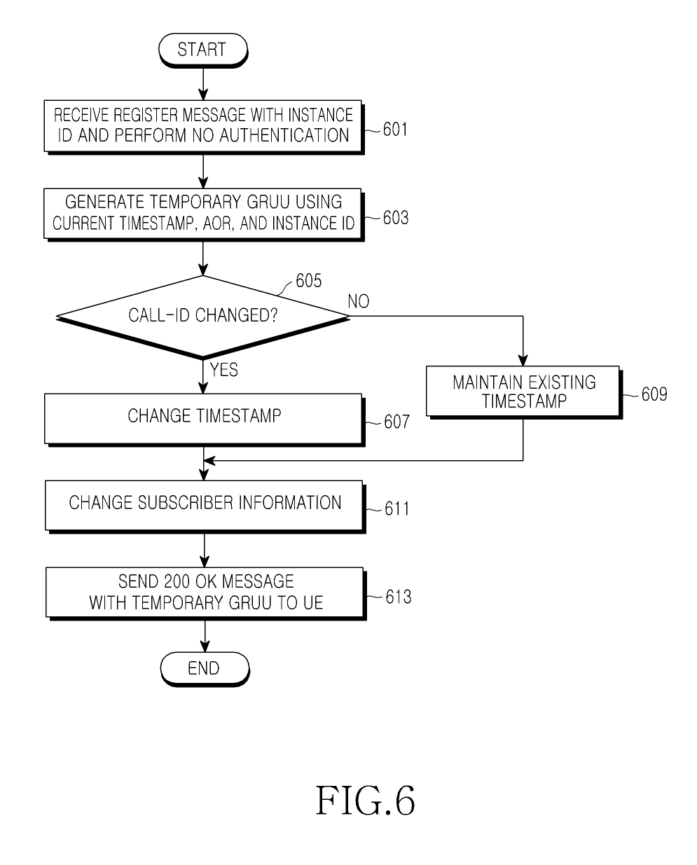

FIG. 6 shows the re-registration process of FIG. 3 by an S-CSCF in an IMS system according to an embodiment of the present invention.

Unlike in FIGS. 2 and 5, the S-CSCF 129 receives a REGISTER message with an Instance Id but does not perform authentication procedure in step 601.

In step 603, the S-CSCF 129 generates a temporary GRUU using the current timestamp, a Public Id (or aor), and a Private Id (or Instance Id), as shown by reference numeral 320 in FIG. 3.

In step 605, the S-CSCF 129 determines whether a Call-Id used during registration has been changed. If the Call-Id used during registration has been changed, the S-CSCF 129 changes the timestamp value in step 607. In step 611, the S-CSCF 129 reflects the changed timestamp value in subscriber information, and if there is any change even in the other information except for the changed timestamp value, the S-CSCF 129 reflects the change in subscriber information (i.e., the previously generated temporary GRUU is invalid). However, if the Call-Id used during registration has not been changed, the S-CSCF 129 maintains the existing timestamp value in step 609 (i.e., the previously generated temporary GRUU is valid). Similarly, in step 611, if there is any change even in the other subscriber information except for the existing timestamp value, the S-CSCF 129 reflects the change in subscriber information.

In step 613, the S-CSCF 129 sends a 200 OK message to a UE 100 via an I-CSCF 128 and a P-CSCF 127, the 200 OK message having a Contact header in which the generated GRUU information (i.e., the last generated temporary GRUU) is included.

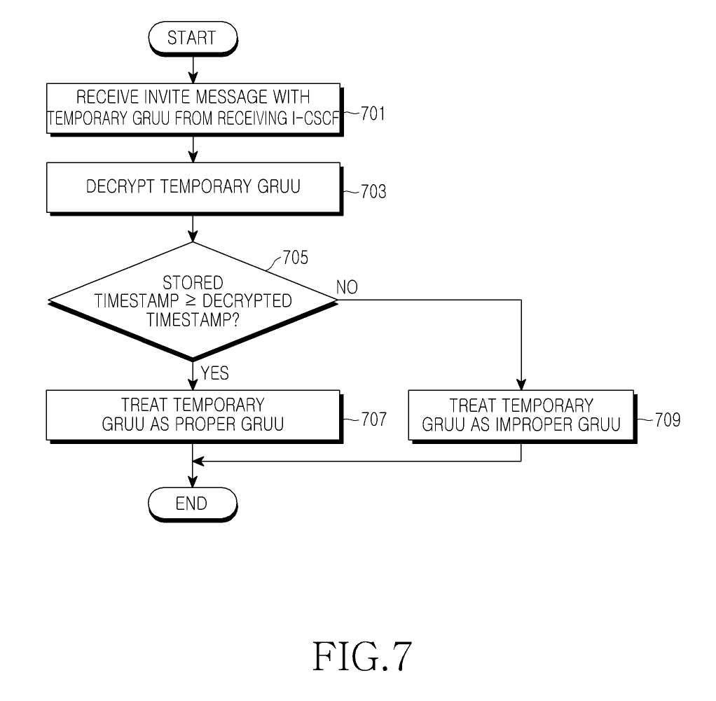

FIG. 7 shows the temporary GRUU validity check procedure of FIG. 4 by an S-CSCF in an IMS system according to an embodiment of the present invention.

In step 701, the S-CSCF 140 receives an INVITE message with a temporary GRUU from a receiving I-CSCF 130. Upon receiving the INVITE message, the S-CSCF 140 obtains a timestamp, a Public Id and a Private Id by decrypting the temporary GRUU in step 703, if Request-URI corresponds to the temporary GRUU. In step 705, the S-CSCF 140 compares the decrypted timestamp with the timestamp being managed as the subscriber. If the timestamp of the temporary GRUU included in Request-URI, i.e., the decrypted timestamp, is greater than or equal to the timestamp being managed as a subscriber, the S-CSCF 140 sends the INVITE message to a P-CSCF 150 in step 707, treating the temporary GRUU as a proper GRUU. However, if the decrypted timestamp is less than the existing timestamp, the S-CSCF 140, though not shown, sends a 480 Temporarily Unavailable message to treat the temporary GRUU as an improper GRUU, in step 709.

As described above, it should be noted that while a receiving S-CSCF may check whether a recipient's temporary GRUU used in a Request-URI is valid, a sending S-CSCF may check whether a sender's temporary GRUU used in a Contact header is valid. Additionally, an operation of checking validity of a temporary GRUU in the sending S-CSCF may be the same as the operation of steps 703 to 709 in FIG. 7 if the sending S-CSCF receives a sender's temporary GRUU used in a Contact header.

As is apparent from the foregoing description, since a temporary GRUU includes aor and Instance-Id (replaceable with Private Id in 3GPP) as its elements, the aor and Instance-Id may be found by decrypting the temporary GRUU using a symmetric key, and the timestamp already included in registration information of an aor-Instance Id pair may be used for validity check, making it unnecessary to generate and manage a separate DB. In case of 3GPP, if a P-CSCF and an I-CSCF share the fixed symmetric key managed in an S-CSCF and the temporary GRUU generation algorithm, even the P-CSCF and I-CSCF may decrypt the temporary GRUU.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for generating a temporary Globally Routable User Agent URI (GRUU) by a Serving-Call Session Control Function (S-CSCF) in an IP multimedia subsystem (IMS) system, comprising:
upon receiving a registration request message from an Interrogating-Call Session Control Function (I-CSCF), performing an authentication procedure;
generating a temporary GRUU based on a current timestamp, and an Address Of Record (aor) and an Instance Identifier (Id) included in the registration request message; and
transmitting the generated temporary GRUU to a User Equipment (UE) along with a contact header.

2. The method of claim 1, further comprising:
requesting subscriber information from a Home Subscriber Server (HSS);
receiving subscriber information from the HSS; and
storing the subscriber information received from the HSS together with the timestamp.

3. The method of claim 1, wherein generating the temporary GRUU comprises:
outputting an encryption result value by encrypting a reference time M and a fixed key K_e using an Advanced Encryption Standard (AES) algorithm, the reference time M including the timestamp, the aor, and the Instance Id; and
generating a userpart of the temporary GRUU by applying the encryption result value to base64 for URL.

4. The method of claim 1, further comprising:
acquiring a pair of a private Id and a public Id of a subscriber from the registration request message received from the I-CSCF, and determining whether an Authentication Vector (AV) corresponding to the private Id is present;
sending an AV request message to an HSS if the AV is not present; and
receiving from the HSS an AV answer message including a subscriber's private Id and information about the number of required AVs.

5. The method of claim 1, further comprising generating a temporary GRUU based on the current timestamp, and a public Id and a private Id included in the registration request message.

6. A method for generating a temporary Globally Routable User Agent URI (GRUU) by a Serving-Call Session Control Function (S-CSCF) in an IP multimedia subsystem (IMS) system, comprising:
upon receiving a re-registration request message from an Interrogating-Call Session Control Function (I-CSCF), generating a temporary GRUU using a current timestamp, and an Address Of Record (aor) and an instance Identifier (Id) included in the re-registration request message without an authentication procedure;
changing subscriber information, if a Call-Id header used during initial registration has been changed; and
transmitting the generated temporary GRUU to a User Equipment (UE) along with a contact header.

7. The method of claim 6, wherein the subscriber information includes a timestamp.

8. The method of claim 6, further comprising generating a temporary GRUU based on the current timestamp, and a public Id and a private Id included in the re-registration request message.

9. The method of claim 6, wherein generating the temporary GRUU comprises:
outputting an encryption result value by encrypting a reference time M and a fixed key K_e using an Advanced Encryption Standard (AES) algorithm, the reference time M including the timestamp, the aor, and the Instance Id; and
generating a userpart of the temporary GRUU by applying the encryption result value to base64 for URL.

10. A method for determining validity of a temporary Globally Routable User Agent URI (GRUU) by a receiving Serving-Call Session Control Function (S-CSCF) in an IP multimedia subsystem (IMS) system, comprising:
receiving an INVITE message with a temporary GRUU from a receiving Interrogating-Call Session Control Function (I-CSCF);
acquiring a timestamp, a public Identifier (Id) and a private Id by decrypting the temporary GRUU if a Request-URI included in the INVITE message corresponds to the temporary GRUU; and
comparing a timestamp value obtained by the decryption with a timestamp value being managed in subscriber information, and determining validity of the temporary GRUU according to the comparison result.

11. The method of claim 10, wherein the temporary GRUU is treated as a valid GRUU if the timestamp value obtained by the decryption is greater than or equal to the timestamp value being managed in the subscriber information.

12. The method of claim 10, wherein the temporary GRUU is treated as an invalid GRUU if the timestamp value obtained by the decryption is less than the timestamp value being managed in the subscriber information.

13. The method of claim 10, further comprising acquiring the timestamp, the aor and the instance Id by decrypting the temporary GRUU if the Request-URI included in the INVITE message corresponds to the temporary GRUU.

14. The method of claim 10, further comprising acquiring a timestamp being managed in the subscriber information, using the public Id and the private Id.

15. A method for determining validity of a temporary Globally Routable User Agent URI (GRUU) by a sending Serving-Call Session Control Function (S-CSCF) in an IP multimedia subsystem (IMS) system, comprising:
acquiring a timestamp, a public Identifier (Id) and a private Id by decrypting a temporary GRUU included in a contact header; and
comparing a timestamp value obtained by the decryption with a timestamp value being managed in subscriber information, and determining validity of the temporary GRUU according to the comparison result.

16. The method of claim 15, wherein the temporary GRUU is treated as a valid GRUU if the timestamp value obtained by the decryption is greater than or equal to the timestamp value being managed in subscriber information.

17. The method of claim 15, wherein the temporary GRUU is treated as an invalid GRUU if the timestamp value obtained by the decryption is less than the timestamp value being managed in subscriber information.

18. The method of claim 15, further comprising acquiring a timestamp, an aor and an instance Id by decrypting the temporary GRUU included in the contact header.

19. The method of claim 15, further comprising acquiring the timestamp being managed in subscriber information, using the public Id and the private Id.
